(19) United States
(12) Patent Application Publication
(10) Pub. No.: US 2013/0115392 A1
(43) Pub. Date: May 9, 2013

(54) HOUSING AND METHOD FOR MAKING SAME

(71) Applicants: REN-BO WANG, Shenzhen City (CN); XIN-WU GUAN, Shenzhen City (CN)

(72) Inventors: REN-BO WANG, Shenzhen City (CN); XIN-WU GUAN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/451,067

(22) Filed: Apr. 19, 2012

(30) Foreign Application Priority Data
Nov. 4, 2011 (CN) 201110344696.6

(51) Int. Cl. B32B 17/12; C03B 19/00

(52) U.S. Cl. 428/34.5; 65/48

(57) ABSTRACT

A housing is made of colored glaze, and the colored glaze is a kind of glass comprising lead dioxide. The housing comprises fibers embedded therein. The housing is strengthened by introducing fibers into the housing. The fibers can also form a pattern and improve the appearance of the housing.

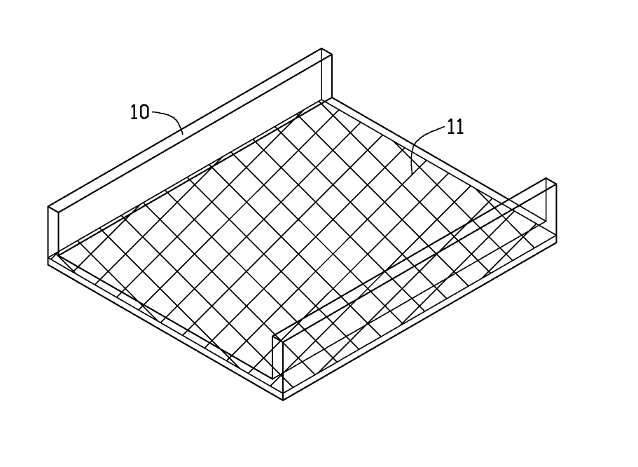

### BACKGROUND

1. Technical Field

The present disclosure relates to housings and method for making the housings, especially to a housing made of colored glaze and method for making the housing.

2. Description of Related Art

Many housings of portable electronic devices are made of metal or plastic, which cannot present a novel and attractive appearance.

Colored glaze is a kind of glass containing lead dioxide, and is aesthetically appealing. However, the colored glaze is brittle and can break easily. Accordingly, a housing made of colored glaze usually has poor strength.

Therefore, there is room for improvement within the art.

### BRIEF DESCRIPTION OF THE FIGURE

Many aspects of the housing can be better understood with reference to the following drawing. The components in the drawing are not necessarily drawn to scale, the emphasis instead being placed upon clearly illustrating the principles of the housing. Moreover, in the drawing like reference numerals designate corresponding parts throughout the drawing.

The FIGURE is a schematic view of an exemplary embodiment of a housing.

### DETAILED DESCRIPTION

The FIGURE shows a housing 10 according to an exemplary embodiment. The housing 10 is made of colored glaze. Colored glaze is a kind of glass containing lead dioxide with a mass percentage of about 10% to about 20%. The transmittance of light through the colored glaze is about 70% to about 90%. The housing 10 made of the colored glaze may be red, blue, green, yellow, golden or brown. The housing 10 can also have composite colors.

The housing 10 includes fibers 11 embedded therein. The fiber 11 can be glass fiber, carbon fiber, or boron fiber. The fibers 11 prevent micro-cracks from forming in the housing 10, and improve the strength and flexibility of the housing 10. The fibers 11 may be weaved to form a pattern, which improves the aesthetics of the housing 10.

The housing 10 has a good chemical durability, and acid and alkali corrosion resistance. The housing 10 also has high hardness, wear resistance, and high strength. The housing 10 presents crystal-like appearance and a vibrant color.

A method for making the housing 10 may include the following steps:

A substrate is formed.

The substrate is made by injection molding. Colored glaze blocks are used as a material and are melted at an environmental temperature of about 600° C. to 800° C. Then the molten colored glaze is injected into a mold (not shown) and solidifies to form a substrate having a desired shape.

The fibers 11 are embedded in the substrate.

When the substrate is not fully solidified, woven fibers 11 are located on a surface of the substrate. Then the fibers 11 and the substrate are pressed together to be combined together to form an integral body. The fibers 11 may be pre-designed fiber cloths. The fiber cloths can form a pattern which may improve the aesthetics of the housing 10.

A surface layer is formed on the substrate integrated with the fibers 11.

The surface layer is formed by an injection molding process. The substrate integrated with the fibers 11 is located in a mold (not shown). Colored glaze blocks are used as material and are melted at an environmental temperature of about 600° C. to 800° C., then the molten colored glaze is injected into the mold and solidifies to form the surface layer having a desired shape on the substrate. As such, the housing 10 is formed.

The housing 10 can then be trimmed and polished.

The housing 10 obtained by the above method has a rough surface. A trimming treatment and then a polishing treatment may be applied to the housing 10 to improve the smoothness. The trimming process may be carried out using a computer numerical control engraving machine. After being trimmed and polished, the surface roughness of the housing 10 is about 0.8 μm.

The housing 10 may be a shell of electronic device, such as a mobile phone

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing, the housing being made of colored glaze, wherein the colored glaze is glass comprising lead dioxide, the housing has fibers embedded therein.

2. The housing as claimed in claim 1, wherein the lead dioxide has a mass percentage of about 10% to about 20% in the colored glaze.

3. The housing as claimed in claim 1, wherein transmittance of light through the housing is about 70% to about 90%.

4. The housing as claimed in claim 1, wherein the fiber is glass fiber, carbon fiber or boron fiber.

5. The housing as claimed in claim 1, wherein the fibers form a pattern.

6. A method for making a housing, comprising:
injection molding colored glaze comprising lead dioxide to form a substrate;
locating woven fibers on a surface of the substrate when the substrate is not fully solidified, and pressing together the fibers and the substrate to combine them together to form an integral body; and
forming a surface layer on the surface of the substrate integrated with the fibers by injection molding colored glaze on the surface of the substrate.

7. The method as claimed in claim 6, wherein forming the substrate further comprises:
melting colored glaze blocks at an environmental temperature of about 600° C. to about 800° C.; injecting the molten colored glaze into a mold and solidifying the molten colored glaze to form the substrate.

8. The method as claimed in claim 6, wherein the fiber is glass fiber, carbon fiber or boron fiber.

9. The method as claimed in claim 6, wherein forming the surface layer further comprises:
melting colored glaze blocks at an environmental temperature of about 600° C. to about 800° C.; injecting the molten colored glaze into a mold and solidifying the molten colored glaze to form the surface layer.

10. The method as claimed in claim 6, wherein the method further includes trimming and polishing the housing.

11. The method as claimed in claim 6, wherein the colored glaze is glass comprising lead dioxide.

12. The method as claimed in claim 11, wherein the lead dioxide has a mass percentage of about 10% to about 20% in the colored glaze.
